(19) United States
(12) Patent Application Publication
(10) Pub. No.: US 2024/0375417 A1
(43) Pub. Date: Nov. 14, 2024

(54) PRINTER AND CUTTER UNIT

(71) Applicant: FCL Components Limited, Tokyo (JP)

(72) Inventor: Tatsuya Oguchi, Tokyo (JP)

(21) Appl. No.: 18/606,641

(22) Filed: Mar. 15, 2024

(30) Foreign Application Priority Data
May 12, 2023 (JP) 2023-079614

(51) Int. Cl. B41J 11/70

(52) U.S. Cl. CPC B41J 11/70

(57) ABSTRACT

A printer has a fixed blade, a movable blade configured to be displaced relative to the fixed blade, and the movable blade has a first movable blade portion inclined from one longitudinal end toward a substantially longitudinal center in a direction opposed to the fixed blade, and a second movable blade portion, which is separated from the first movable blade portion, inclined from another longitudinal end toward the substantially longitudinal center in the direction opposed to the fixed blade. The printer has a holding member configured to rotatably hold the first and second movable blade portions so that a shearing angle formed by the fixed blade and the first or second movable blade portion is variable, and an elastic deformable member configured to urge the first and second movable blade portions in a predetermined direction and elastically deformable, depending on a magnitude of a cutting resistance.

### CROSS-REFERENCE TO RELATED APPLICATIONS

This application is based upon and claims the benefit of priority of the prior Japanese Patent Application No. 2023-079614 filed on May 12, 2023, the entire content of which is incorporated herein by reference.

### BACKGROUND

A certain aspect of the embodiments is related to a printer and a cutter unit.

In a typical thermal printer, an object to be printed, such as printing paper, is sandwiched between a platen roller and a thermal head, and printing is performed by heating the thermal head while feeding the printing paper. Some printers have a V-shaped cutter with a V-shaped blade and/or a rotary cutter with a spiral blade for cutting paper after printing.

A typical V-shaped cutter has a linear fixed blade parallel to a surface of the printing paper and a V-shaped movable blade with a concave center, wherein the movable blade can be moved toward the fixed blade so as to cut the paper smoothly.

When cutting printed paper with a V-shaped cutter, the larger the shearing angle of the movable blade, the lower the cutting load. Therefore, when paper to be printed on is relatively thick, a movable blade with a large shearing angle can smoothly cut the paper, but when the shearing angle is small, it is necessary to use a high-power or large motor as a drive source for the movable blade. On the other hand, when the paper to be printed on is relatively thin, smooth cutting is possible even with a movable blade having a small shearing angle, but when the shearing angle is large, the paper tends to bend in a V-shape. With such a V-shaped cutter having a constant shearing angle, it is difficult to set a shearing angle which realizes smooth and suitable cutting of both thin paper and thick paper without increasing the size of the drive source for the movable blade.

### RELATED ART

[Patent Literature 1] JP 2007-196348 A
[Patent Literature 2] JP 2004-106502 A

### SUMMARY

A compact printer and cutter unit, capable of automatically changing the shearing angle, depending on the thickness of the paper and cutting both thin paper and thick paper, are therefore in demand.

One aspect of the present disclosure is a printer comprising: a fixed blade; a movable blade configured to be displaced relative to the fixed blade, the movable blade having a first movable blade portion inclined from one longitudinal end toward a substantially longitudinal center in a direction opposed to the fixed blade, and a second movable blade portion, which is separated from the first movable blade portion, inclined from another longitudinal end toward the substantially longitudinal center in the direction opposed to the fixed blade; a holding member configured to rotatably hold the first and second movable blade portions so that a shearing angle formed by the fixed blade and the first or second movable blade portion is variable; and an elastic deformable member configured to urge the first and second movable blade portions in a predetermined direction and elastically deformable, depending on the magnitude of cutting resistance.

Another aspect of the present disclosure is a cutter unit comprising: a movable blade configured to be displaced relative to a fixed blade, the movable blade having a first movable blade portion inclined from one longitudinal end toward a substantially longitudinal center in a direction opposed to the fixed blade, and a second movable blade portion, which is separated from the first movable blade portion, inclined from another longitudinal end toward the substantially longitudinal center in the direction opposed to the fixed blade; a holding member configured to rotatably hold the first and second movable blade portions so that a shearing angle formed by the fixed blade and the first or second movable blade portion is variable; and an elastic deformable member configured to urge the first and second movable blade portions in a predetermined direction and elastically deformable, depending on the magnitude of cutting resistance.

According to the present disclosure, a compact and low-cost printer and cutter unit is provided, wherein the shearing angle of the movable blade automatically changes according to the thickness of the paper, and thus both thin paper and thick paper can be cut smoothly.

### BRIEF DESCRIPTION OF DRAWINGS

FIG. 1 is an exploded perspective view of a thermal printer according to an embodiment.

FIG. 2 is a perspective view of the thermal printer of FIG. 1.

FIG. 3 is a perspective view of a part of a cutter unit.

FIG. 4 is a view of a movable blade and a holding member.

FIG. 5 is a cross-sectional view along an A-A line of FIG. 1.

FIG. 6 is a view showing a state in which the movable blade is sliding in FIG. 5.

FIG. 7 shows a comparative example in which thin paper is cut by a cutter having a constant shearing angle.

FIG. 8 shows an example in which thin paper is cut by a cutter having a shearing angle larger than that of FIG. 7.

FIG. 9 shows an example in which the thin paper is deformed.

FIG. 10 shows a comparative example in which thick paper is cut by the cutter having the constant shearing angle.

FIG. 11 shows an example in which thick paper is cut by a cutter having a shearing angle larger than that of FIG. 10.

FIG. 12 shows state in which the shearing angle is varied from the state of FIG. 4.

FIG. 13 is a partial enlarged view of a holding structure for the movable blade.

FIG. 14 is a cross-sectional view along a B-B line of FIG. 13.

FIG. 15 is a cross-sectional view along a C-C line of FIG. 13.

FIG. 16 shows an example of an operation for attaching the movable blade to the holding structure.

FIG. 17 is an enlarged view of a part D of FIG. 16.

FIG. 18 shows an example of an operation for attaching the movable blade to the holding structure.

FIG. 19 is an enlarged view of a part E of FIG. 18.

FIG. 20 is an enlarged view of a dropping-prevention part.

FIG. 21 is an enlarged view of the holding member.

FIG. 22 is a cross-sectional view along an F-F line of FIG. 21, before the movable blade is attached.

FIG. 23 is a cross-sectional view along an F-F line of FIG. 21, when the movable blade is being attached.

FIG. 24 is a cross-sectional view along an F-F line of FIG. 21, after the movable blade is attached.

FIG. 25 shows a stated of the movable blade before cutting thin paper.

FIG. 26 shows a stated of the movable blade after cutting the thin paper.

FIG. 27 shows a stated of the movable blade before cutting thick paper.

FIG. 28 shows a stated of the movable blade after cutting the thick paper.

FIG. 29 is an enlarged view of a part G of FIG. 27.

FIG. 30 is an enlarged view of a part H of FIG. 28.

### DESCRIPTION OF EMBODIMENTS

Hereinafter, a description will be given of the embodiment of the present invention with reference to the drawings.

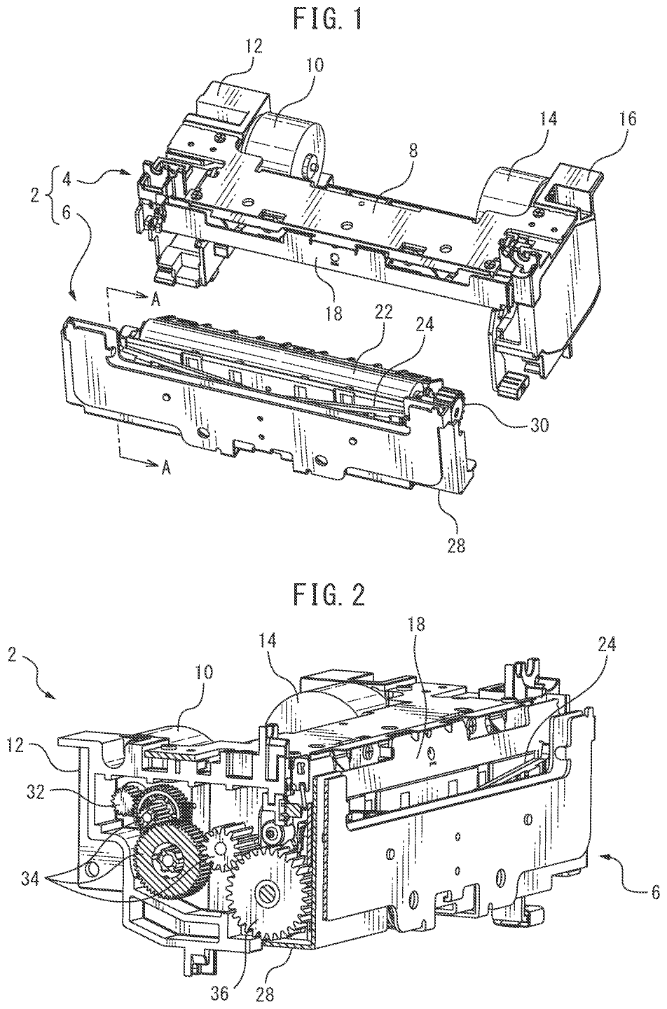

FIG. 1 is an exploded perspective view of a thermal printer 2 according to a preferred embodiment, and FIG. 2 is a perspective view of the thermal printer 2 viewed from a different angle from that of FIG. 1. The thermal printer 2 includes a printer unit 4 and a cutter unit 6 which are used in combination with each other. The printer unit 4 includes a cutter drive motor 10 supported by or attached to a support 8 such as a frame, a feed motor 14, and a fixed blade 18. The cutter drive motor 10 is connected to a gear (described below) arranged in a gear box 12. Further, the feed motor 14 is connected to a gear (not shown) arranged in a gear box 16.

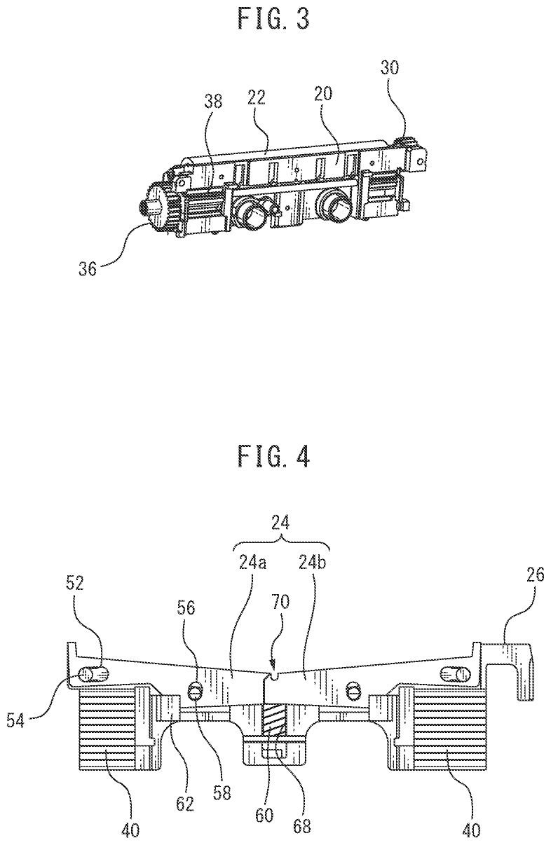

FIG. 3 shows a state in which a movable blade and a holding member, which will be described below, are removed from the cutter unit 6. The cutter unit 6 has a platen roller 22 supported by or attached to a main body 20, the platen roller 22 has a driven gear 30 at its axial end, and the driven gear 30 is engaged with a gear (not shown) in the gear box 16. Therefore, the platen roller 22 is rotated by driving the feed motor 14, whereby an object to be printed and cut, such as thin paper or thick paper, can be fed.

FIG. 4 shows a movable blade 24 and a holding member 26 included in the cutter unit 6. The movable blade 24 has a substantial V-shape configured to be linearly displaceable in a direction substantially perpendicular to a surface of the object to be cut such as thin or thick paper, relative to a fixed blade 18 having a cutting edge substantially parallel to the surface of the object to be cut. The holding member 26 is attached to a reinforcing metal plate 28 shown in FIG. 2, is configured to rotatably support the movable blade 24 as described below, and has a rack portion 40 which engages with a gear 38 shown in FIG. 3.

The pair of pinching plates 26a and 26b are arranged apart from each other by a predetermined distance on the bottom side. In the illustrated example, the pair of pinching plates 26a and 26b are biased toward each other by the coil springs 28a and 28b, respectively, and are retained so as to be separated by a constant distance by a support part 30 constructed as a part of the holder 24.

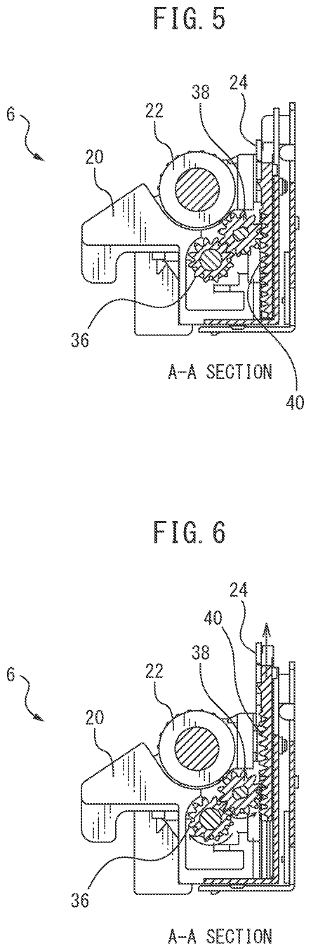

FIGS. 5 and 6 show a mechanism for moving the movable blade 24 relative to the fixed blade 18. As shown in FIG. 1, when the motor 10 is driven, gears 36 and 38 for driving the movable blade rotate via gears 32 and 34, and the holding member 26 having a rack 40 engaged with the gear 38 is moved up and down. Along with this, the movable blade 24 held by the holding member 26 is also moved up and down, and can cut printing paper, such as thin paper or thick paper, placed between the movable blade 24 and the fixed blade 18.

Referring again to FIG. 4, the movable blade 24 has a plurality of movable blade portions which can be displaced independently of each other relative to the fixed blade 18. Specifically, the movable blade 24 includes a first movable blade portion 24a which is inclined from one end in a longitudinal direction (width direction of the printer) toward a substantially longitudinal center in a direction opposite to the fixed blade 18, and a second movable blade portion 24b which is a separate member from the first movable blade portion 24a and is inclined from another longitudinal end toward the substantially longitudinal center in the direction opposite to the fixed blade 18. In the illustrated example, the first movable blade portion 24a corresponds to one side of the substantial V-shape, the second movable blade portion 24b corresponds to the other side of the substantial V-shape, and the movable blade portions 24a and 24b cooperatively form the substantially V-shaped movable blade 24 which is convex in the direction opposite to the fixed blade 18. Further, each of the movable blade portions 24a and 24b is held by the holding member 26 so that the apex angle of the V-shape is variable, which will be described in more detail later.

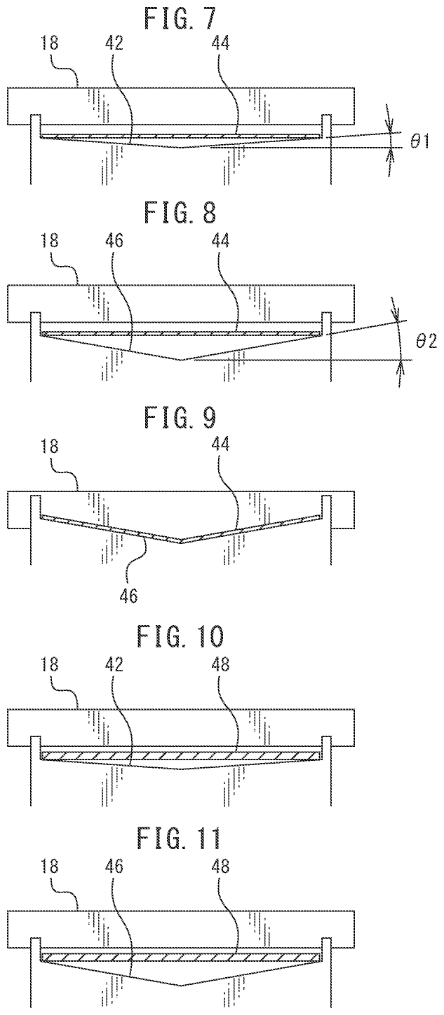

FIGS. 7 to 11 shows, as a comparative example, one wherein thin or thick paper is cut with a cutter in which a shearing angle formed by fixed and movable blades is constant. In general, the cutting load applied to a cutter decreases as the thickness of an object to be cut decreases, and increases as the thickness increases. Furthermore, the larger the shearing angle, the lower the cutting load. Therefore, as shown in FIG. 7, when the object to be cut is thin paper 44, it is preferable to use a movable blade 42 and the fixed blade 18 which form a relatively small shearing angle θ1. Conversely, as shown in FIG. 8, when trying to cut thin paper 44 using a movable blade 46 and the fixed blade 18 which form a relatively large shearing angle θ2, the thin paper 44 having low rigidity may be bent into a V-shape, depending on the shape of the movable blade 46 as shown in FIG. 9, making it difficult to cut smoothly.

On the other hand, as shown in FIG. 10, in a case where the object to be cut is thick paper 48, the cutting load is large when the movable blade 42 and fixed blade 18 forming the relatively small shearing angle θ1 are used, and thus the drive source (for example, a motor) for the movable blade 42 should be made larger. However, this may lead to an increase in the size and cost of the printer. Conversely, as shown in FIG. 11, when the movable blade 46 and fixed blade 18 forming the relatively large shearing angle θ2 are used, the thick paper 48 can be cut smoothly with a low cutting load.

As explained above, it is not easy to smoothly cut both thin paper and thick paper using a cutter having a constant shearing angle, and consequently, in the prior art, determining and evaluating specifications, such as the shearing angle of the blade can be a time-consuming process.

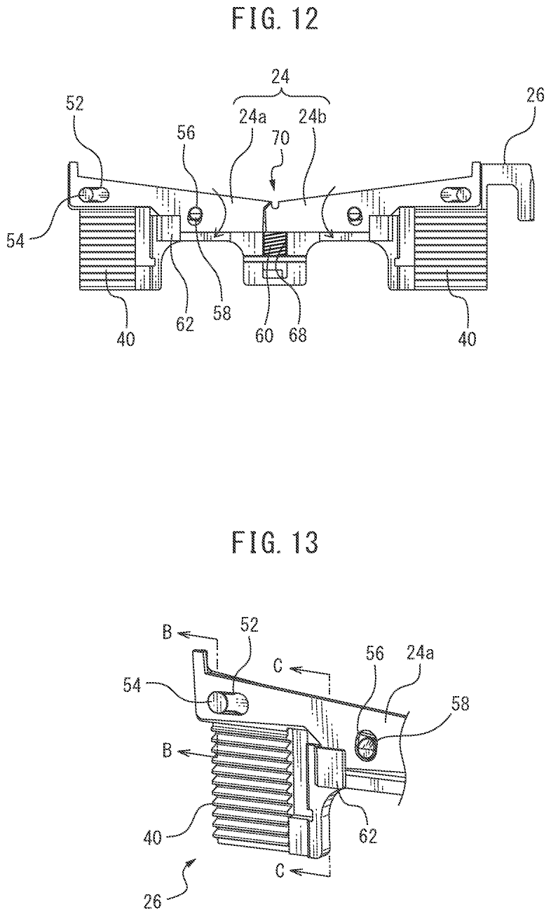

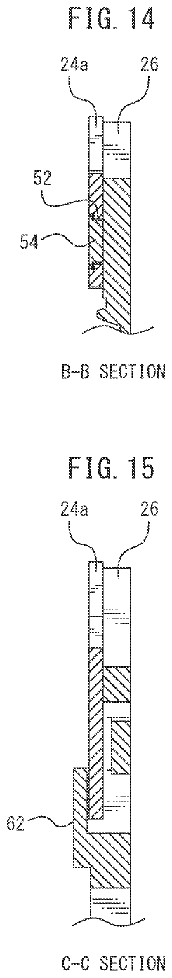

Therefore, in the present disclosure, as shown in FIGS. 4 and 12, a structure is used in which the shearing angle can be automatically changed, depending on the thickness of the object to be cut. Specifically, as shown in FIGS. 13 to 15, the first movable blade portion 24a has a hole 52 at its outer end in the longitudinal direction, and the hole 52 is configured to receive a rotation fulcrum portion 54 formed on the holding member 26. Further, the movable blade portion 24a has an elongated hole 56 inside the hole 52 in the longitudinal direction, and which is configured to receive a substantially cylindrical stopper portion 58 formed on the holding member 26. Therefore, as shown in FIG. 12, the movable blade portion 24a is rotatable about the rotation fulcrum portion 54, and the rotation angle range thereof is defined within a predetermined range by the elongated hole 56. It is preferable that the holding member 26 have a dropping-prevention portion 62 configured to hold the movable blade portion 24a so as to prevent it from dropping from the holding member 26, more specifically, so that the movable blade portion 24a is not displaced toward the front in the direction perpendicular to the drawing as in FIG. 4 or 12.

The inner end portion of the first movable blade portion 24a in the longitudinal direction terminates at the apex of the generally V-shaped movable blade 24, and is urged in a predetermined direction by an elastic deformable member 60 disposed in a recess 68 formed at the substantially longitudinal center of the holding member 26. Specifically, the first movable blade portion 24a is urged by the elastic deformable member 60 in a direction in which the shearing angle becomes smaller, i.e., in a direction in which the apex angle of the V-shape of the movable blade 24 becomes larger. Further, the second movable blade portion 24b, which has a generally bilaterally symmetrical relationship with the first movable blade portion 24a, is also configured to be rotatable within a predetermined angular range, similarly to the first movable blade part 24a, and the inner end portion of the second movable blade portion 24b in the longitudinal direction is urged by the elastic deformable member 60 in a predetermined direction, specifically, in a direction in which the shearing angle becomes smaller. Therefore, the shearing angle of the movable blade 24 formed by the movable blade portions 24a and 24b is variable, depending on the amount of deformation of the clastic deformable member 60. Further, the amount of deformation of the elastic deformable member 60 depends on a reaction force received from the paper when cutting the paper, i.e., the cutting resistance. Therefore, the shearing angle of the movable blade 24 automatically changes, depending on the magnitude of the cutting resistance. Concretely, the shearing angle becomes smaller when cutting thin paper, and becomes larger when cutting thick paper. In this way, the elastically deformable member 60 urges the movable blade portions 24a and 24b in the direction in which the shearing angle becomes smaller, and elastically deforms in the direction in which the shearing angle becomes larger, depending on the magnitude of cutting resistance.

Although the elastically deformable member 60 in the illustrated example is a coil spring, it is not limited to this, and may be another member which provides the above-mentioned effects, such as a plate spring. Further, the movable blade 24, for example, is made of metal, while the holding member 26, for example, is made of resin. However, the present disclosure is not limited to these.

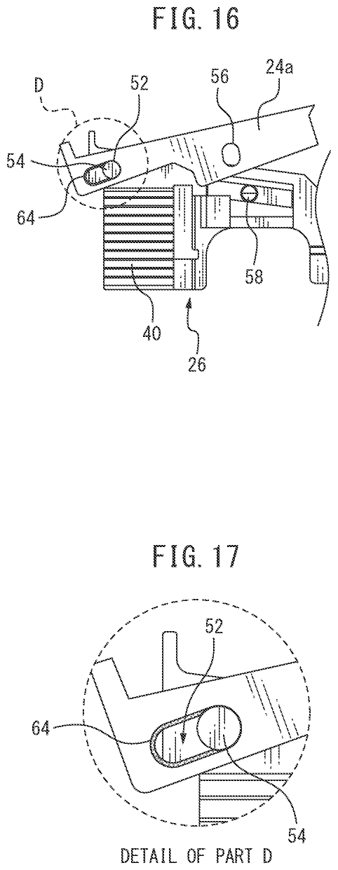

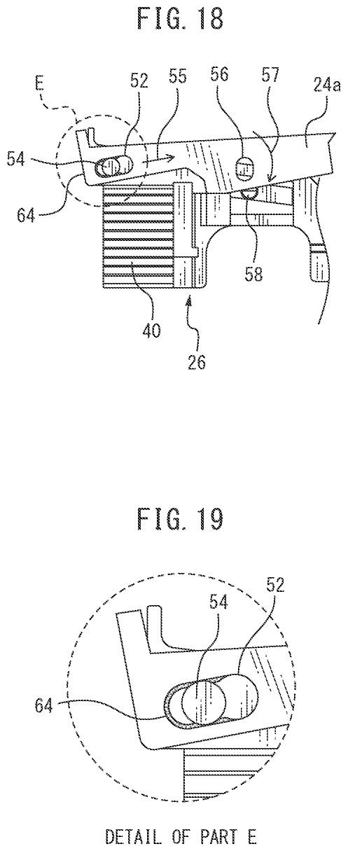

FIGS. 16 to 20 show an example of an operation for attaching the movable blade portion 24a to the holding member 26. First, as shown in FIG. 16, the rotation fulcrum portion 54 of the holding member 26 is inserted into the hole 52 of the movable blade portion 24a. In this case, as shown in FIG. 17, the hole 52 is an elongated hole which has a partial rail portion 64 extending inward from the inner wall of the hole 52, and the rotation fulcrum portion 54 has an upper end portion having a dimension larger than the distance between the rail portions 64 of the opposing long sides of the elongated hole 52. Therefore, as shown in FIGS. 18 and 19, after the rotation fulcrum portion 54 of the holding member 26 is inserted into the hole 52 at a location where the rail part 64 is not provided, the rotation fulcrum portion 54 engages with the rail part 64 by moving the movable blade portion 24a relative to the holding member 26 in the direction of an arrow 55, whereby the movable blade portion 24a is positioned relative to the holding member 26 without dropping therefrom.

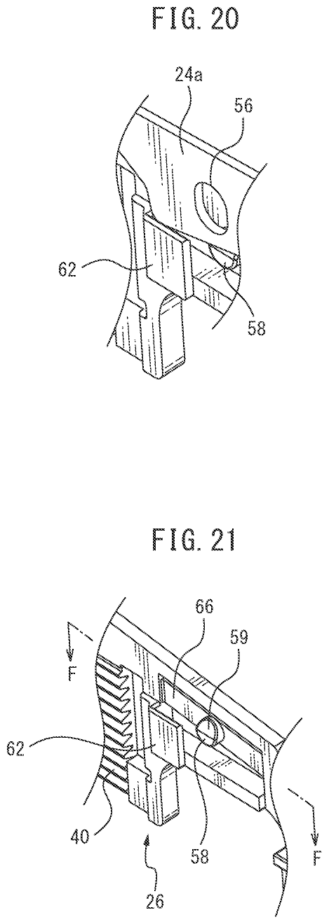

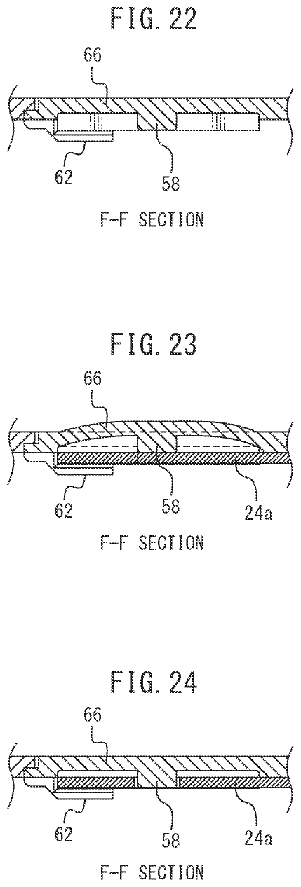

Next, as shown in FIGS. 18 and 20, the movable blade portion 24a is rotated in the direction of an arrow 57 so that the first movable blade portion 24a is inserted between the stopper portion 58 and the dropping-prevention portion 62. Here, as shown in FIGS. 20 and 21, the stopper portion 58 has an inclined surface 59 on an upper part in the direction of the cutting edge of the movable blade part 24a, so as the movable blade portion 24a is rotated, the movable blade portion 24a rides on the stopper portion 58. In this case, as shown in FIG. 22, the stopper portion 58 is formed on a thin part 66 of the holding member 26, which is thinner than other parts, whereby the thin part 66 is elastically deformed as shown in FIG. 23. When the movable blade portion 24a is further rotated from this state, the stopper portion 58 fits into the elongated hole 56 of the movable blade portion 24a, as shown in FIG. 24, and the deformed thin part 66 returns to its original state.

The second movable blade portion 24b can also be attached to the holding member 26 by a similar operation. In this way, the movable blade portions 24a and 24b can be attached to the holding member 26 so as to be rotatable within the predetermined angle.

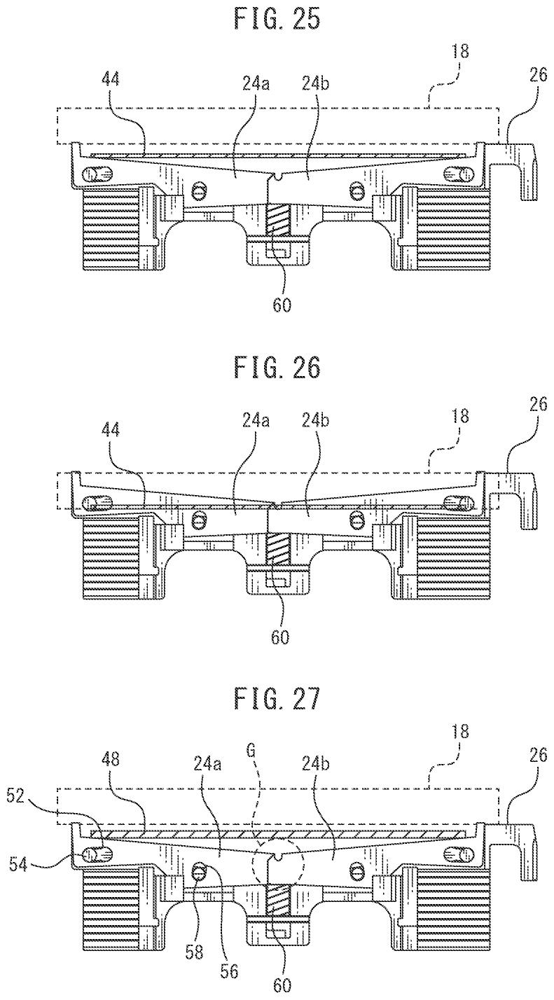

FIGS. 25 and 26 show an example in which thin paper 44 is cut by the movable blade 24 and fixed blade 18 according to the embodiment. Before cutting as shown in FIG. 25, the shearing angle of the movable blade is at its minimum due to the urging force from the elastic deformable member 60, but since the cutting resistance due to the thin paper 44 is relatively small, even during cutting as shown in FIG. 26, the clastic deformable member 60 does not substantially undergo clastic deformation, and therefore the shearing angle does not substantially change. In other words, the clastic deformable member 60 is configured so as not to be substantially deformed by the cutting resistance from the thin paper 44. For example, when the elastic deformable member 60 is a coil spring, the coil spring 60 has a spring constant so that the coil spring is not substantially deformed by the cutting resistance from the thin paper 44. Therefore, the thin paper 44 can be cut with the small shearing angle, so as to be cut smoothly without bending along the V-shape of the movable blade, unlike the example of FIG. 9.

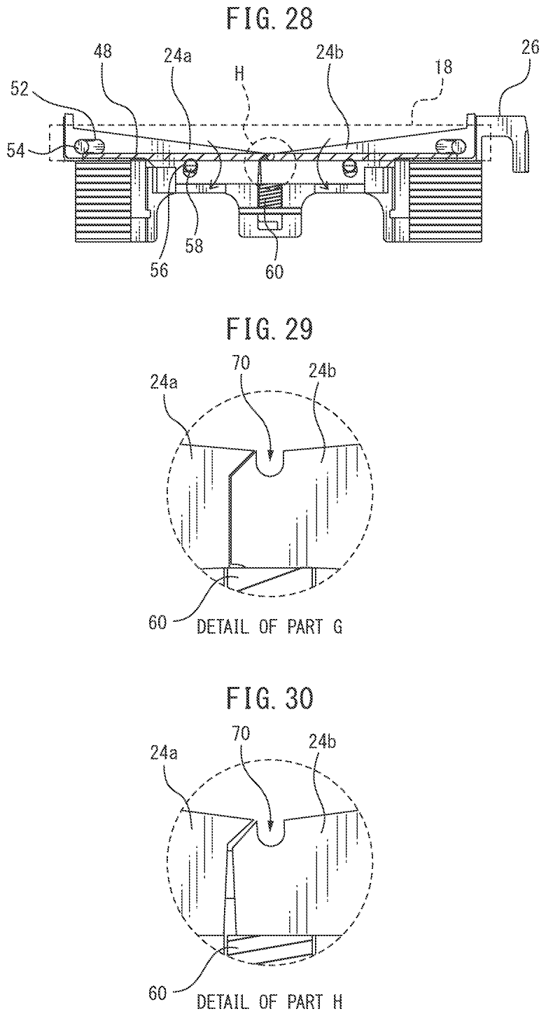

FIGS. 27 and 28 show an example in which thick paper 48 is cut by the movable blade 24 and fixed blade 18 according to the embodiment. Before cutting as shown in FIG. 27, the shearing angle is at its minimum due to the urging force from the elastically deformable member 60, but since the cutting resistance due to the thick paper 48 is relatively large, during cutting as shown in FIG. 28, the clastic deformable member 60 is elastically deformed, and therefore the shearing angle increases. In other words, the clastic deformable member 60 is configured to be elastically deformed by the cutting resistance from the thick paper 48. For example, when the clastic deformable member 60 is a coil spring, it has a spring constant such that the coil spring is compressed by the cutting resistance from the thick paper 48. Therefore, the thick paper 48 can be smoothly cut with a large shearing angle, without increasing the size of the drive source for the movable blade.

In the embodiment, the shearing angle can be appropriately determined, based on the shape of the movable blade 24 and the dimensions of the elongated hole 56, etc., and can be made variable within, for example, a range of 5 to 10 degrees. In this case, thin paper with low cutting resistance can be cut with a minimum shearing angle of 5°, while thick paper can be cut with a shearing angle of 7 to 10°, depending on its thickness. The thin paper in the present disclosure is, for example, receipt paper with a thickness of 50 to 80 μm, while the thick paper, for example, is ticket paper or the like with a thickness of 100 to 200 μm.

As described above, in the embodiment, by appropriately selecting the spring constant of the coil spring 60, a movable blade can be realized in which the shearing angle thereof does not change when cutting thin paper 44 and automatically increases when cutting thick paper 48. Therefore, according to the present disclosure, it is possible to smoothly cut both thin paper and thick paper without increasing the size of the motor for driving the movable blade, whereby a compact yet versatile printer and cutter unit are provided.

FIGS. 29 and 30 are enlarged views of a part G in FIG. 27 and a part H in FIG. 28, respectively, and show a preferred configuration example of the movable blade when the cutter unit is of a so-called partial cut type. In general, in a printer having a V-shaped movable blade, by forming a groove at a part of the movable blade, it is possible to perform so-called partial cutting, in which paper is not completely cut. However, in this embodiment, since the movable blade 24 is divided into the movable blade portions 24a and 24b at approximately the center, when a recess, etc., is formed in each of the movable blade portions 24a and 24b so that the recesses cooperatively form one groove, the shape and size of the groove are changed when the movable blade portions 24a and 24b are rotated. Therefore, the length of an uncut portion of the paper also changes, and as a result, desired partial cutting may not be performed.

Therefore, as shown in FIG. 29, it is preferable to form, for example, a U-shaped groove 70 for partial cutting only in one of the movable blade portions 24a and 24b (in the illustrated example, the second movable blade portion 24b). In other words, in this example, the movable blade portions 24a and 24b are asymmetrical with respect to each other, and are fitted into each other at a position away from the longitudinal center of the movable blade 24 toward one end side thereof, thereby forming a substantially V-shaped movable blade 24, and the groove 70 for partial cutting is formed only in one of the movable blade portions 24a and 24b. In this way, even when the movable blade portions 24a and 24b are rotated as shown in FIG. 30, the shape and size of the U-shaped groove 70 does not change, so the length of the uncut portion of the paper will also not change. As a result, desired partial cutting can be performed.

Although the embodiments of the present disclosure relate to thermal printers, the present disclosure is not limited to this, but is applicable to other types of printers having a sliding cutter unit in which a movable blade moves linearly relative to a fixed blade. Further, although the fixed blade 18 is arranged in the printer unit 4 in the embodiment, it can also be arranged in the cutter unit 6. Furthermore, although the elastic deformable member 60 is one coil spring in the embodiment, two or more coil springs may be arranged, depending on the number of movable blade portions, or an clastic deformable member other than the coil spring may be used as described above.

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations can be made hereto without departing from the spirit and scope of the invention.

What is claimed is:

1. A printer comprising:
a fixed blade;
a movable blade configured to be displaced relative to the fixed blade, the movable blade having a first movable blade portion inclined from one longitudinal end toward a substantially longitudinal center in a direction opposed to the fixed blade, and a second movable blade portion, which is separated from the first movable blade portion, inclined from another longitudinal end toward the substantially longitudinal center in the direction opposed to the fixed blade;
a holding member configured to rotatably hold the first and second movable blade portions so that a shearing angle formed by the fixed blade and the first or second movable blade portion is variable; and
an elastic deformable member configured to urge the first and second movable blade portions in a predetermined direction and elastically deformable, depending on a magnitude of a cutting resistance.

2. The printer according to claim 1, wherein each of the first and second movable blade portions is rotatable about a rotation fulcrum portion formed on the holding member, and a rotation angle range of each the first and second movable blade portions is determined by an elongated hole formed in each of the first and second movable blade portions and a stopper portion formed on the holding member and received in the elongated hole.

3. The printer according to claim 1, wherein the first and second movable blade portions are asymmetrical relative to each other, and cooperatively form the movable blade having a substantial V-shape by fitting with each other at a position apart from the longitudinal center of the movable blade toward one of the longitudinal end.

4. The printer according to claim 3, wherein a groove for partial cutting is formed on only one of the first and second movable blade portions.

5. A cutter unit comprising:
a movable blade configured to be displaced relative to a fixed blade, the movable blade having a first movable blade portion inclined from one longitudinal end toward a substantially longitudinal center in a direction opposed to the fixed blade, and a second movable blade portion, which is separated from the first movable blade portion, inclined from another longitudinal end toward the substantially longitudinal center in the direction opposed to the fixed blade;
a holding member configured to rotatably hold the first and second movable blade portions so that a shearing angle formed by the fixed blade and the first or second movable blade portion is variable; and
an elastic deformable member configured to urge the first and second movable blade portions in a predetermined direction and elastically deformable, depending on a magnitude of a cutting resistance.
